(19) United States
(12) Patent Application Publication
(10) Pub. No.: US 2026/0074443 A1
(43) Pub. Date: Mar. 12, 2026

(54) TOOL DRIVEN SPLICE CONNECTORS

(71) Applicant: Hubbell Incorporated, Shelton, CT (US)

(72) Inventors: Peter Norman Therrien, Deerfield, NH (US); Connor Owen Douglas Buckley, Manchester, NH (US); Bradley Steven Elliott, Epping, NH (US); Brian Royal Ellis, Dover, NH (US)

(21) Appl. No.: 19/320,487

(22) Filed: Sep. 5, 2025

Related U.S. Application Data
(60) Provisional application No. 63/691,476, filed on Sep. 6, 2024.

(51) Int. Cl. H01R 4/50; H01R 11/32; H01R 43/26

(52) U.S. Cl. CPC H01R 4/5016; H01R 4/5075; H01R 11/32; H01R 43/26

(57) ABSTRACT

A connector assembly has a connector body having a plurality of conductor apertures and a plurality of fastener bores, and a plurality of hammer driven fasteners. In one configuration, each of the plurality of conductor apertures can extend through the connector body from one side of the connector body to an opposite side of the connector body, and each of the plurality of fastener bores extend from an end of the connector body into the connector body a predefined depth so that one fastener bore intersects one conductor aperture. In another configuration, each of the plurality of conductor apertures extend through the connector body from one end of the connector body into the connector body a predetermined depth, and each of the plurality of fastener bores extend from a side of the connector body into the connector body a predefined depth so that one fastener bore intersects one conductor aperture.

### CROSS-REFERENCE TO RELATED APPLICATIONS

This application is based on and claims benefit from co-pending U.S. Provisional Patent Application No. 63/691,476 filed on Sep. 6, 2024 entitled “Hammer Driven Splice Connector” the contents of which are incorporated herein in its entirety by reference.

### FIELD

The present disclosure relates to connectors for electrical conductors that provide a permanent electrical connection between two or more electrical conductors. More particularly, the present disclosure relates to hammer driven splice connectors that provide a permanent electrical connection between two or more electrical conductors.

### DESCRIPTION OF THE RELATED ART

Compression connectors have been used to irreversibly connect or join electrical conductors together. With compression connectors, to irreversibly connect or join electrical conductors together, the compression connector is placed in a standard crimping tool, such as a hydraulic 12-ton or 15-ton hand-held power tool, that has dies in a working head of the tool.

When the tool is activated, the dies engage the compression connector and compress the connector to irreversibly connect or join electrical conductors together. An example of a hydraulic power tool is the 15-Ton PATRIOT® PAT46 crimper, manufactured by Burndy, LLC. Such hydraulic power tools are expensive so that users often justify the purchase of such tools when there are many crimps to be made.

The present disclosure provides a more economical alternative for situations where there is a lower number of crimps to irreversibly connect large size electrical conductors together is desired.

### SUMMARY OF THE DISCLOSURE

The present disclosure provides embodiments of hammer driven splice connector assemblies that irreversibly splice or join large size electrical conductors. In an exemplary embodiment, the connector assembly includes a connector body and a plurality of hammer driven fasteners. The connector body includes a plurality of conductor apertures and a plurality of fastener bores. Each of the plurality of conductor apertures extend through the connector body from one side of the connector body to an opposite side of the connector body. Each of the plurality of fastener bores extend from an end of the connector body into the connector body a predefined depth so that one fastener bore intersects one conductor aperture. One of the plurality of fasteners is positioned in one of the plurality of fastener bores. Each of the plurality of fasteners includes an impacting surface at a first end of the fastener and an contact surface at a second end of the fastener. The impacting surface extends outside the respective fastener bore, and the contact surface is within the intersection between the fastener bore and the conductor aperture.

In another exemplary embodiment, the connector assembly includes a connector body and a plurality of hammer driven fasteners. The connector body includes a plurality of conductor apertures and a plurality of fastener bores. Each of the plurality of conductor apertures extend through the connector body from one end of the connector body into the connector body a predetermined depth. Each of the plurality of fastener bores extend from a side of the connector body into the connector body a predefined depth so that one fastener bore intersects one conductor aperture. One of the plurality of fasteners is positioned in one of the plurality of fastener bores. Each of the plurality of fasteners includes an impacting surface at a first end of the fastener and an contact surface at a second end of the fastener. The impacting surface extends outside the respective fastener bore, and the contact surface is within the intersection between the fastener bore and the conductor aperture.

In another exemplary embodiment, the connector assembly includes a connector body and a plurality of fasteners. Preferably, an exterior wall of the connector body is shaped as a circular wall or as a square wall. The connector body includes a plurality of conductor apertures and a plurality of fastener bores. Each of the plurality of conductor apertures extend through the connector body from one side of the connector body to an opposite side of the connector body. In some embodiments, the plurality of conductor apertures are substantially parallel. Each of the plurality of fastener bores extend from an end of the connector body into the connector body a predefined depth so that the one of the fastener bores intersects one of the conductor apertures.

One of the plurality of fasteners is positioned in one of the plurality of fastener bores. In some embodiments, each fastener includes an impacting surface at a first end portion of the fastener and a wire contact surface at a second end portion of the fastener. The impacting surface is configured to extend outside the respective fastener bore, e.g., out of an exterior wall of the connector body. The contact surface is within the intersection between the respective fastener bore and the respective conductor aperture, and is configured such that when in use, the wire contact surface can indent a conductor positioned within the respective conductor aperture. In some embodiments, an exterior wall of the second end portion of the fastener is tapered such that a smaller end of the taper forms the wire contact surface. In some embodiments, each of the plurality of fasteners includes a body having a central portion disposed between the first end portion and the second end portion, wherein at least the central portion includes an exterior wall that is configured to fit snuggly within the one fastener bore such that there is little to no gap between the exterior wall of the central portion and an interior wall of the one fastener bore. In some embodiments, a shape of an exterior wall of the central portion is substantially the same as a shape of the respective fastener bore. As a non-limiting example, the shape of the fastener bore can be substantially circular and the shape of the exterior wall of the central portion can be substantially circular.

In another exemplary embodiment, the connector assembly includes a connector body and a plurality of fasteners. Preferably, an exterior wall of the connector body is shaped as a circular wall or as a square wall. The connector body includes a plurality of conductor apertures and a plurality of fastener bores. Each of the plurality of conductor apertures extend from one end of the connector body into the connector body a predetermined depth. In some embodiments, the plurality of conductor apertures are substantially parallel. Each of the plurality of fastener bores extend from a side of the connector body into the connector body a predefined depth such that one of the fastener bores intersects one of the conductor apertures. One of the plurality of fasteners is positioned in one of the plurality of fastener bores. In some embodiments, each fastener includes an impacting surface at a first end portion of the fastener and a wire contact surface at a second end portion of the fastener. The impacting surface is configured to extend outside the respective fastener bore, e.g., out of an exterior wall of the connector body. The contact surface is within the intersection between the respective fastener bore and the respective conductor aperture, and is configured such that when in use, the wire contact surface can indent a conductor positioned within the respective conductor aperture. In some embodiments, an exterior wall of the second end portion of the fastener is tapered such that a smaller end of the taper forms the wire contact surface. In some embodiments, each of the plurality of fasteners includes a body having a central portion disposed between the first end portion and the second end portion, wherein at least the central portion includes an exterior wall that is configured to fit snuggly within the one fastener bore such that there is little to no gap between the exterior wall of the central portion and an interior wall of the one fastener bore. In some embodiments, a shape of an exterior wall of the central portion is substantially the same as a shape of the respective fastener bore. As a non-limiting example, the shape of the fastener bore can be substantially circular and the shape of the exterior wall of the central portion can be substantially circular.

In another exemplary embodiment, the connector assembly includes a connector body, a first fastener and a second fastener. The connector body includes first and second conductor apertures and first and second fastener bores. The first aperture extends through the connector body from one side of the connector body to an opposite side of the connector body. Similarly, the second aperture extends through the connector body from one side of the connector body to an opposite side of the connector body. Preferably, the first and second apertures are parallel. The first fastener bore extends from a first end of the connector body into the connector body a predefined depth so that the first fastener bore intersects the first conductor aperture. Similarly, the second fastener bore extends from a second end of the connector body into the connector body a predefined depth so that the second fastener bore intersects the second conductor aperture. The first fastener is positioned in the first fastener bore. The first fastener includes an impacting surface at a first end portion and a wire contact surface at a second end portion. The impacting surface extends outside the first fastener bore, e.g., out of an exterior wall of the connector body. The contact surface is within the intersection between the first fastener bore and the first conductor aperture. The second fastener is positioned in the second fastener bore. The second fastener includes an impacting surface at a first end portion and a wire contact surface at a second end portion. The impacting surface extends outside the second fastener bore, e.g., out of an exterior wall of the connector body. The contact surface is within the intersection between the second fastener bore and the second conductor aperture.

In some embodiments, each of the first and second fasteners includes a body having a central portion disposed between the first end portion and the second end portion. At least the central portion includes an exterior wall that is configured to fit snuggly within the first or second fastener bores such that there is little to no gap between the exterior wall of the central portion and an interior wall of the first or second fastener bores. In some embodiments, the wire contact surface of the first and second fasteners is configured such that when in use, the wire contact surface can indent a conductor positioned within the first or second conductor aperture. In some embodiments, an exterior wall of the second end portion of the first and second fasteners is tapered such that a smaller end of the taper forms the wire contact surface.

### BRIEF DESCRIPTION OF THE DRAWINGS

To further clarify the above and other advantages and features of the subject matter of this patent specification, specific examples of embodiments thereof are illustrated in the appended drawings. It should be appreciated that these drawings depict only exemplary embodiments and are therefore not to be considered limiting of the scope of this patent specification or the appended claims. The subject matter hereof will be described and explained with additional specificity and detail through the accompanying drawings in which:

FIG. 1 is a perspective view of an exemplary embodiment of a connector assembly according to the present disclosure, illustrating a connector body having parallel conductor apertures and a plurality of fasteners;

FIG. 1A is a perspective view of another exemplary embodiment of a connector assembly according to the present disclosure, illustrating a connector body having offset conductor apertures and a plurality of fasteners;

FIG. 2 is a side elevation view of the connector assembly of FIG. 1;

FIG. 3 is an exploded perspective view of the connector assembly of FIG. 1;

FIG. 4 is a first side elevation view of an exemplary embodiment of the connector body of the connector assembly of FIG. 1;

FIG. 5 is a second side elevation view of the connector body of the connector assembly of FIG. 4;

FIG. 6 is a top perspective view of the connector body of FIG. 4, illustrating a fastener bore;

FIG. 7 is a first side perspective view of an exemplary embodiment of the fastener of the connector assembly of FIG. 1;

FIG. 8 is a second side perspective view of the fastener of FIG. 7;

FIG. 9 is a top plan view of the fastener of FIG. 7, illustrating an exemplary embodiment of an impact surface of the fastener;

FIG. 10 is a side elevation view of the fastener of FIG. 7;

FIG. 11 is a bottom plan view of the fastener of FIG. 7, illustrating an exemplary embodiment of an contact surface of the fastener;

FIG. 12 is a perspective view of the connector assembly of FIG. 1, illustrating an electrical conductor staged for insertion into each conductor aperture in the connector body and the fasteners associated with each conductor aperture set in an open position;

FIG. 13 is a side elevation view of the connector assembly of FIG. 12, illustrating the electrical conductors inserted into each respective conductor aperture in the connector body, and illustrating one of the fasteners the associated with one of the electrical conductors hammered to a clamping position and one of the fasteners associated with the other conductor aperture staged for hammered into the clamping position;

FIG. 14 is a perspective view of the connector assembly of FIG. 13, illustrating the electrical conductors secured to the connector body using the fasteners;

FIG. 15 is a perspective view of another exemplary embodiment of a connector assembly according to the present disclosure, illustrating a connector body having a plurality of in-line conductor apertures and a plurality of fasteners;

FIG. 16 is a side elevation view of the connector assembly of FIG. 15;

FIG. 17 is an end elevation view of the connector assembly of FIG. 15;

FIG. 18 is an exploded perspective view of the connector assembly of FIG. 15, illustrating a plurality of fastener bores in the connector body;

FIG. 19 is a top side perspective view of the fastener of FIG. 18;

FIG. 20 is a bottom side perspective view of the fastener of FIG. 18;

FIG. 21 is a top plan view of the fastener of FIG. 19, illustrating an exemplary embodiment of an impact surface of the fastener;

FIG. 22 is a side elevation view of the fastener of FIG. 19;

FIG. 23 is a bottom plan view of the fastener of FIG. 19, illustrating an exemplary embodiment of a contact surface of the fastener;

FIG. 24 is a perspective view of the connector assembly of FIG. 15, illustrating an electrical conductor staged for insertion into each conductor aperture in the connector body and the fasteners associated with each conductor aperture set in an open position;

FIG. 25 is a side elevation view of the connector assembly of FIG. 24, illustrating the electrical conductors inserted into each respective conductor aperture in the connector body, and illustrating one of the fasteners the associated with one of the electrical conductors hammered to a clamping position and one of the fasteners associated with the other conductor aperture staged for hammered into the clamping position; and

FIG. 26 is a perspective view of the connector assembly of FIG. 25, illustrating the electrical conductors secured to the connector body using the fasteners.

### DETAILED DESCRIPTION

Detailed descriptions of exemplary embodiments of electrical conductor connectors are provided. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all such details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

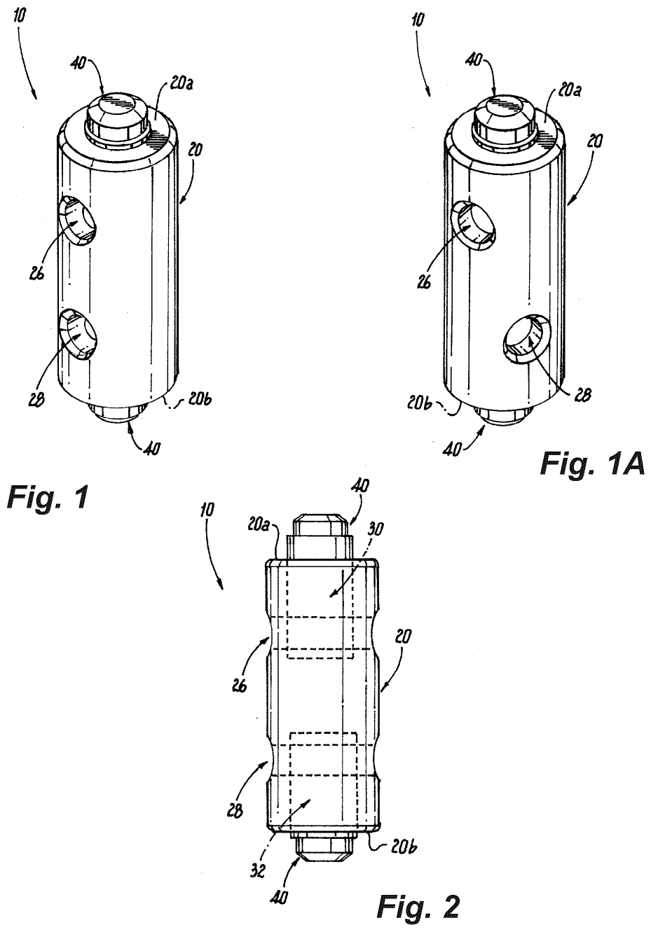

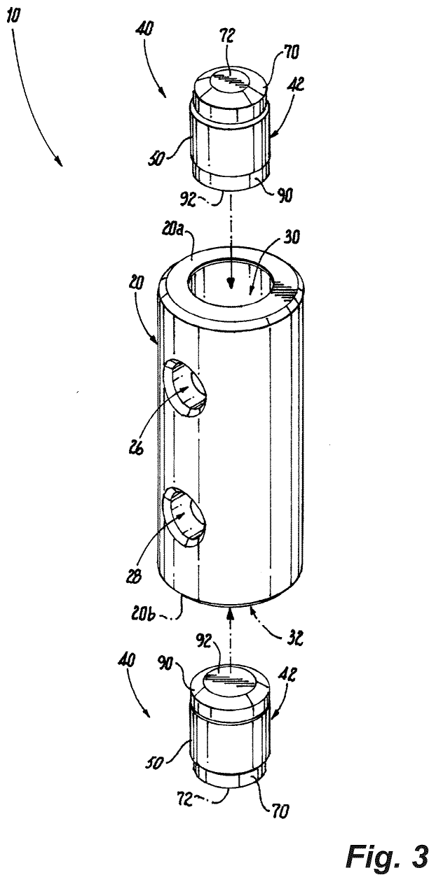

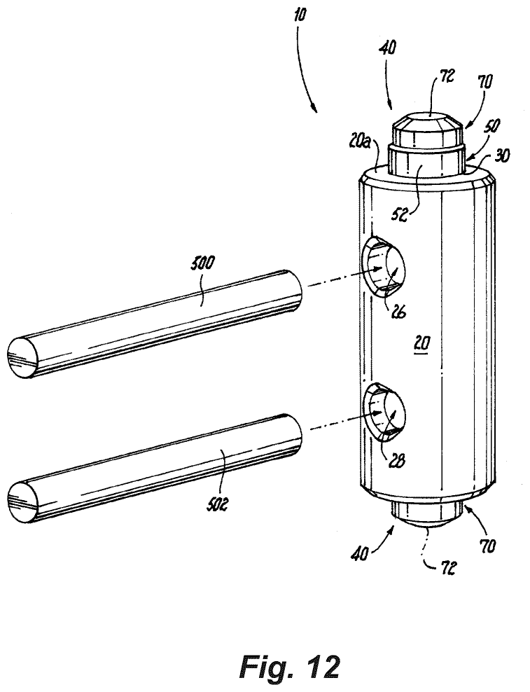

Referring to FIGS. 1-3, an exemplary embodiment of an electrical conductor connector assembly according to the present disclosure is shown. For ease of description, the electrical conductor connector assembly may also be referred to herein as the “connector” in the singular and the “connectors” in the plural. In this exemplary embodiment, connector 10 is a parallel or offset connector that includes a connector body 20 and one or more fasteners 40. The connector body 20 may also be referred to herein as the “body.” The connector 10 may be configured and dimensioned to electrically connect two or more electrical conductors 500 and 502, seen in FIG. 12, such that the two or more electrical conductors 500 and 502 are in electrical communication. The electrical conductors 500 and 502 may also be referred to herein as the “conductors” in the plural and the “conductor” in the singular. The size of the conductors 500 and 502 may vary depending upon the intended purpose of the conductors and requirements set forth in industry standards and/or regulations. The two or more conductors 500 and 502 may be the same size or the conductors may be different size conductors. To illustrate, in some embodiments the conductors 500 and 502 may be the same size, such as a #6 AWG conductor, or in some embodiments, the conductors 500 and 502 may be different in size, such as a #6 AWG conductor 500 and a #2 AWG conductor 502.

Referring now to FIGS. 1-6, the connector body 20 may be a substantially cylindrical member such that an exterior wall of the connector body is substantially circular, although other shaped members may be used to electrically connect two or more electrical conductors 500 and 502 together. Non-limiting examples of other shapes of the connector body 20 include conical, frustoconical and rectangular shapes where the exterior wall of the connector body is substantially circular or square. The connector body 20 is preferably made of an electrically conductive material, such as an electrically conductive metal. Non-limiting examples of electrically conductive metals include copper, aluminum, aluminum alloys, stainless steel, brass. However, the present disclosure contemplates that other electrically conductive materials may be used to fabricate the connector body 20. Non-limiting examples of other electrically conductive materials include graphite and conductive polymers.

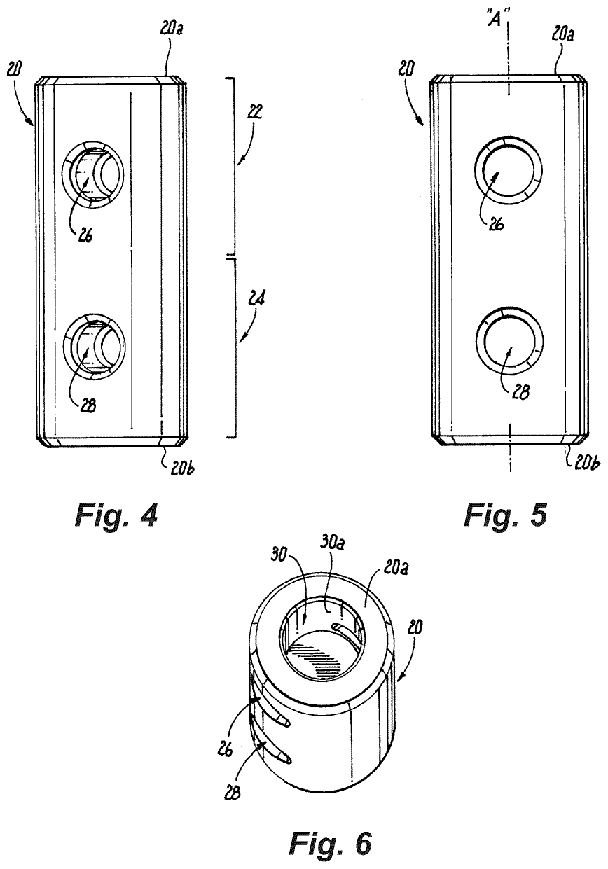

In the exemplary embodiment shown, the connector body 20 is an elongated body having a first end portion 22 and a second end 24, as shown in FIG. 4. The first end portion 22 of the connector body 20 includes an opening, bore or aperture 26 extending into the connector body 20 that is configured and dimensioned to receive a conductor 500, as shown in FIG. 12.

The second end 24 of the connector body 20 includes an opening, bore or aperture 28 extending into the connector body 20 that is configured and dimensioned to receive a conductor 502, as shown in FIG. 12. The apertures 26 and 28 are preferably substantially cylindrical openings extending through the connector body 20 substantially perpendicular to the longitudinal axis “A” of the connector body 20. In the embodiment shown in FIG. 1, the apertures 26 and 28 are substantially parallel to each other. However, the present disclosure contemplates embodiments where the first aperture 26 is at an angle relative to the second aperture 28, as shown in FIG. 1A. The diameter of the apertures 26 and 28 are configured to receive the conductor 500 or 502 the aperture is designed to receive. To illustrate, in one embodiment where the conductors 500 and 502 are the same size, such as a #6 AWG conductor, the diameters of the apertures 26 and 28 would be sized to receive the #6 AWG conductor. In another embodiment, where the conductors 500 and 502 may be different size conductors, such as a #6 AWG conductor 500 and a #2 AWG conductor 502, the diameter of aperture 26 may be sized to receive the #6 AWG conductor 500 and the diameter of aperture 28 may be sized to receive the #2 AWG conductor 502.

Continuing to refer to FIGS. 4-6, the connector body 20 also includes a first fastener opening, aperture or bore 30 extending from a first surface 20a of the connector body 20 into the connector body 20 a depth at least as far as to intersect with the first aperture 26. The first fastener bore 30 is configured and dimensioned to receive one of the fasteners 40 so that the fastener 40 can secure the conductor 500 within aperture 26 with a friction fit or press fit connection. The connector body 20 also includes a second fastener opening, aperture or bore 32, seen in FIG. 2, extending from a second surface 20b of the connector body 20 into the connector body 20 a depth at least as far as to intersect with the second aperture 28. The second fastener bore 32 is also configured and dimensioned to receive one of the fasteners 40 so that the fastener 40 can secure the conductor 502 within aperture 28 with a friction fit or press fit connection. The first fastener bore 30 may have a first diameter at the beginning of the first fastener bore 30, which is at the exterior of the connector body 20, and a second diameter at the end of the first fastener bore 30, which is at a point within the connector body 20 beyond a point where the first fastener bore 30 intersects with the conductor aperture 26. In some exemplary embodiments, the first and second diameters of the first fastener bore 30 may be the same, such that the diameter of the first fastener bore 30 is constant. In other embodiments, the first and second diameters of the first fastener bore 30 may be different. For example, the first diameter may be the widest at the beginning of the first fastener bore 30 and the second diameter may be the narrowest at the end of the first fastener bore 30, and the first diameter may gradually decrease from the beginning to the second diameter at the end of the first fastener bore 30. Similarly, the second fastener bore 32 may have a first diameter at the beginning of the second fastener bore 32, which is at the exterior of the connector body 20, and a second diameter at the end of the second fastener bore 32, which is at a point within the connector body 20 beyond a point where the second fastener bore 32 intersects with the conductor aperture 28. In some exemplary embodiments, the first and second diameters of the second fastener bore 32 may be the same, such that the diameter of the second fastener bore 32 is constant. In other embodiments, the first and second diameters of the second fastener bore 32 may be different. For example, the first diameter may be the widest at the beginning of the second fastener bore 32 and the second diameter may be the narrowest at the end of the first fastener bore 32, and the first diameter may gradually decrease from the beginning to the second diameter at the end of the second fastener bore 32.

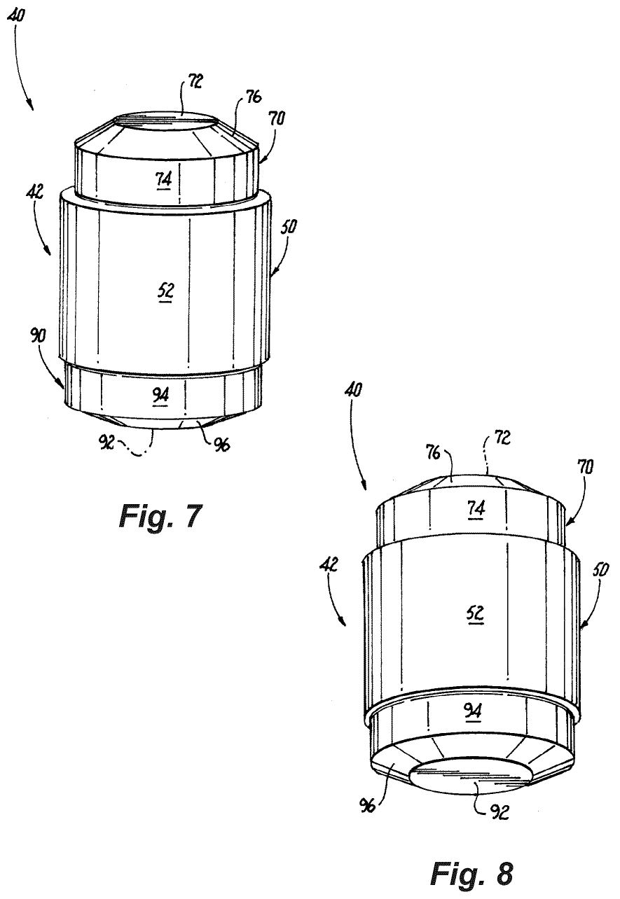

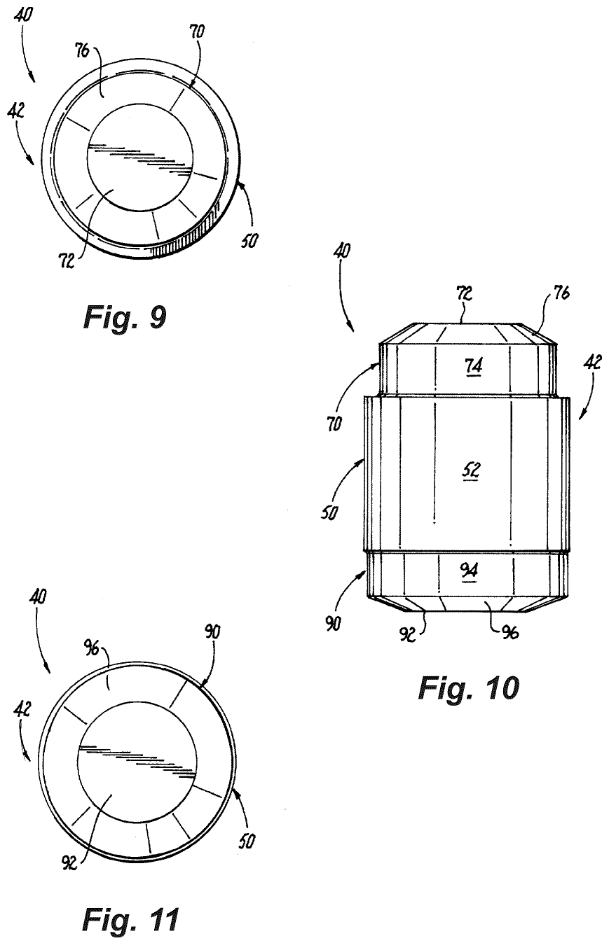

Referring to FIGS. 7-11, in the exemplary embodiment shown, the one or more fasteners 40 are pins configured to fit snuggly within the first fastener bore 30 or the second fastener bore 32, seen in FIG. 2, so that there is little to no gap between the fastener 40 and a wall of the bore 30 or 32, e.g., wall 30a of first fastener bore 30, seen in FIG. 6. The purpose of the snug fit is so that fastener 40 can, preferably, secure a conductor 500 within the first aperture 26 or a conductor 502 within the second aperture 28 with a friction fit or a press fit connection. For ease of description, the one or more fasteners 40 may also be referred to herein as the “pins” in the plural and the “pin” in the singular.

The fastener 40 includes a fastener body 42 having a central portion 50, a first end portion 70 at the first end of the central portion 50 and a second end portion 90 at a second end of the central portion. In the exemplary embodiment shown, the fastener 40 may have an at least a partially cylindrical shape so that the shape of the fastener 40 corresponds to the shape of the first fastener bore 30 and/or the second fastener bore 32. However, the fastener body 42 may have any shape capable of being received in the first fastener bore 30 and/or the second fastener bore 32 so that a conductor 500 and/or 502 can be secured within the first and second apertures 26 and 28 of the connector body 20.

The central portion 50 of the fastener body 42 is disposed between the first end portion 70 and the second end portion 90. The central portion 50 may be substantially cylindrical shaped member that may be a solid member or partially hollow member. Preferably, the central portion 50 has an exterior wall 52 with a predefined diameter configured to fit snuggly within the first fastener bore 30 and/or the second fastener bore 32 so that so that the fastener body 42 can secure a conductor 500 and/or 502 within the first aperture 26 or the second aperture 28 with a friction fit or a press fit connection.

Continuing to refer to FIGS. 7-11, the first end portion 70 of fastener body 42 includes an impact surface 72, which may be a substantially flat surface, seen in FIGS. 7 and 10, that forms at least partially an impact surface used when hammering the fastener 40 into engagement with the conductor 500 or 502 to secure the conductor to the connector body 20. The impact surface 72 is a circular shaped surface, although other shapes, e.g., elliptical, triangular, rectangular, etc., for the impact surface 72 may also be used. In some embodiments, a diameter of the circular impact surface 72 may be smaller than a diameter of the exterior wall 74 of the first end portion 70 of the fastener body 42 so that the impact surface 72 is a raised surface. The impact surface 72 is raised by, for example, a stepped wall, a curved wall, an inclined wall or another shaped wall 76. In the embodiment shown, wall 76 is an inclined wall. The outer diameter of the exterior wall 74 of the first end portion 70 may be smaller than the outer diameter of the exterior wall 52 of the central portion 50. The transition between the exterior wall 52 of the central portion 50 and the exterior wall 74 of the first end portion 70 may be, for example, stepped, curved, inclined or another shaped. In the exemplary embodiment shown, the transition between the exterior wall 52 of the central portion 50 and the exterior wall 74 of the first end portion 70 is stepped.

Continuing to refer to FIGS. 7-11, the second end 90 of the fastener body 42 includes a contact surface 92, which may be a substantially flat surface, seen in FIGS. 8 and 11, that forms at least partially a contact surface used to compress the conductor 500 or 502 against the fastener body 42 when the impact surface 72 of the fastener 40 is hammered into engagement with the connector body 20 to secure the conductor 500 or 502 to the connector body 20. The contact surface 92 may be a circular shaped surface, although other shapes, e.g., elliptical, triangular, rectangular, etc., for the contact surface 92 may also be used. In some embodiments, a diameter of the circular contact surface 92 may be smaller than a diameter of the exterior wall 94 of the second end 90 of the fastener body 42 so that the contact surface 92 is a raised surface. The contact surface 92 is raised by, for example, a stepped wall, a curved wall, an inclined wall or another shaped wall 96. In the embodiment shown, wall 96 is an inclined wall. All or a portion of the contact surface 92 may be textured (not shown) with, for example, ridges, knurling or other rough surface textures. The texture would be provided to enhance the electrical contact between the contact surface 92 and the conductor 500. In some embodiments, the surface area of the contact surface 92 may be at least about 10% of the surface area of the impact surface 72. In other embodiments, the surface area of the contact surface 92 may be at least about 25% of the surface area of the impact surface 72. In other embodiments, the surface area of the contact surface 92 may be at least about 50% of the surface area of the impact surface 72. In still other embodiments, the surface area of the contact surface 92 may be at least about 60% of the surface area of the impact surface 72. In other embodiments, the surface area of contact surface 92 may be at least about 75% of the surface area of the impact surface 72. In still other embodiments, the surface area of the contact surface 92 may be at least about 100% of the surface area of the impact surface 72. It is noted that a larger surface area of the contact surface 92 may more evenly distribute forces across the electrical conductor 500 or 502 so that the force can be applied to, for example, multiple strands of electrical conductor that may be stranded wire.

In the exemplary embodiment shown, the outer diameter of the exterior wall 94 of the second end portion 90 of the fastener body 42 may be smaller than the outer diameter of the exterior wall 52 of the central portion 50 and larger than the diameter of the exterior wall 74 of the first end portion 70. In some embodiments, the transition between the exterior wall 52 of the central portion 50 and the exterior wall 94 of the second end portion 90 may be, for example, stepped, curved, inclined or another shaped. In the exemplary embodiment shown, the transition between the exterior wall 52 of the central portion 50 and the exterior wall 94 of the second end portion 90 is stepped. In this configuration, the step between the central portion 50 and the second end portion 90 may be smaller than the step between the central portion 50 and the first end portion 70. However, in other embodiments, the outer diameter of the exterior wall 94 of the second end portion 90 of the fastener body 42 may be substantially the same size as the outer diameter of the exterior wall 52 of the central portion 50 so that there is substantially no transition between the exterior wall 52 of the central portion 50 and the exterior wall 94 of the second end portion 90.

The fasteners 40 are configured to withstand an impact from a hammer or other suitable tool used drive or otherwise cause the fastener 40 to move within the fastener bore 30 or 32 until the contact surface 92 of the second end 90 of the fastener body 42 applies sufficient force on the conductor 500 or 502 to indent the conductor to secure the conductor 500 or 502 to the connector body 20. The fasteners 40 may be solid members, hollow members or partially hollow members. The fasteners 40 are preferably made of an electrically conductive material, such as an electrically conductive metal. Non-limiting examples of electrically conductive metals include copper, aluminum, aluminum alloys, stainless steel and brass. However, the present disclosure contemplates that other electrically conductive materials may be used to fabricate the fasteners 40. Non-limiting examples of other electrically conductive materials include graphite and conductive polymers.

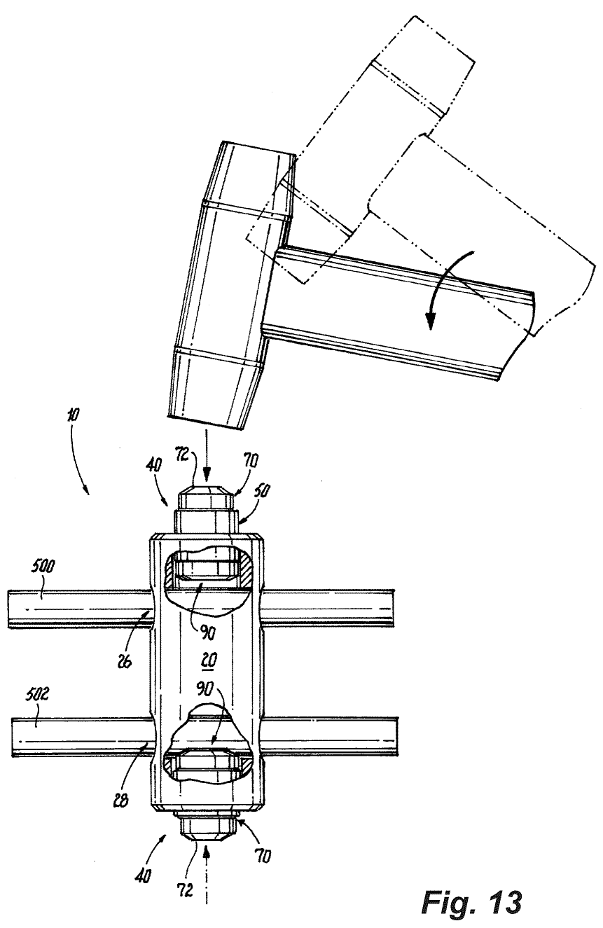

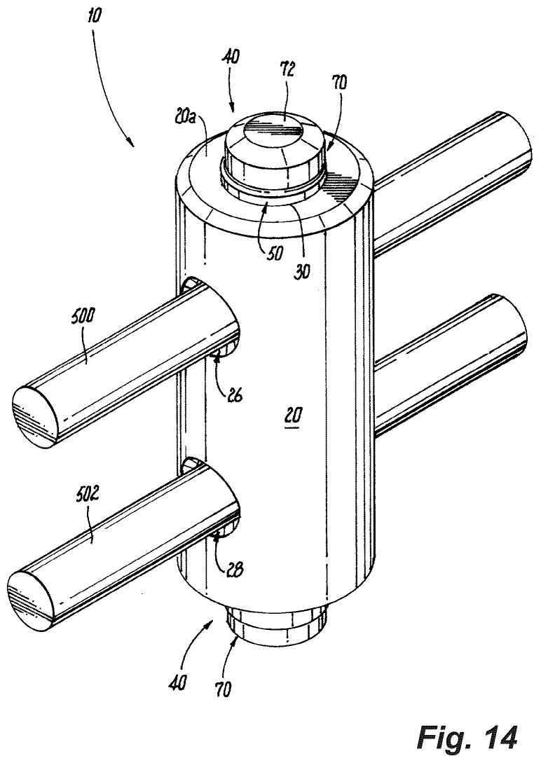

Referring now to FIGS. 12-14, an exemplary description for securing the conductors 500 and 502 to the connector assembly 10 is provided. In this exemplary embodiment, the two fasteners 40 are in an open position where conductor 500 can be inserted into the conductor apertures 26 in the connector body 20, and where conductor 502 can be inserted into the conductor apertures 28 in the connector body 20. A technician then impacts the impacting surface 72 of the first end portion 70 of fastener body 42 with a hammer or other suitable tool causing the fastener 40 to move within the fastener bore 30 or 32 until the contact surface 92 of the second end 90 of the fastener body 42 applies sufficient force on the conductor 500 or 502 to indent the conductor to secure the conductor 500 or 502 to the connector body 20. As the fastener 40 moves within the fastener bore 30 or 32, friction between one or all of the fastener 40 walls and the wall of the fastener bores 30 or 32 increases sufficiently to form friction fit or press fit connection between the connector body and the fastener 40 to irreversibly or permanently connect or join the electrical conductors 500 and 502 together as shown in FIGS. 13 and 14.

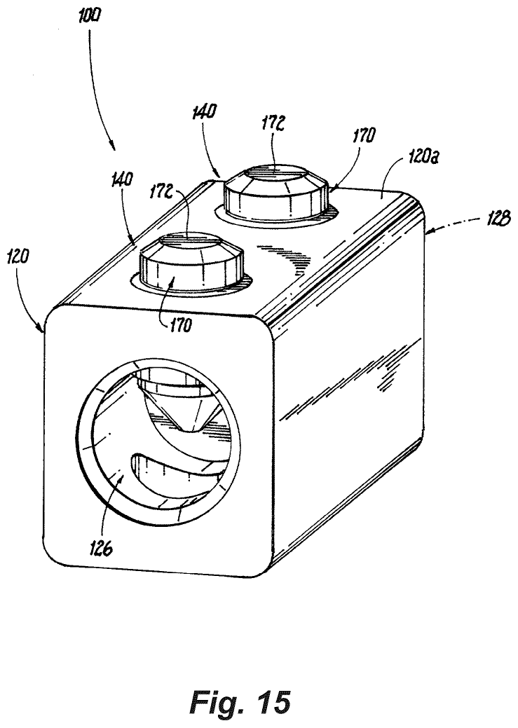

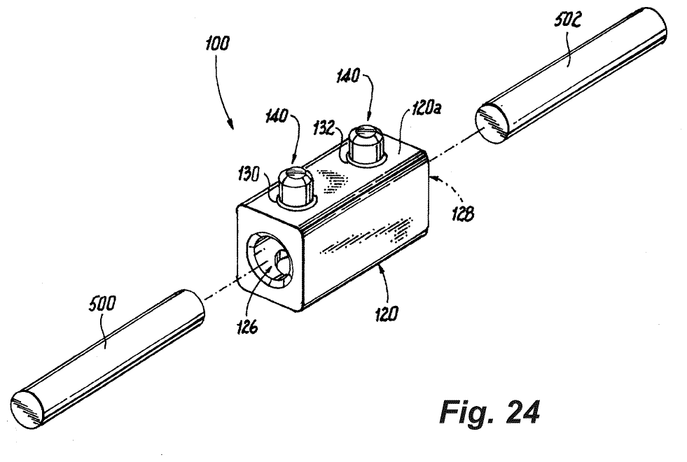

Referring now to FIGS. 15-18, another exemplary embodiment of an electrical conductor connector assembly according to the present disclosure is shown. For ease of description, the electrical conductor connector assembly may also be referred to herein as the “connector” in the singular and the “connectors” in the plural. In this exemplary embodiment, the connector 100 is an in-line connector that includes a connector body 120 and one or more fasteners 140. The connector body 120 may also be referred to herein as the “body.” The connector 100 may be configured and dimensioned to electrically connect two or more electrical conductors 500 or 502, seen in FIG. 24, such that the two or more electrical conductors 500 and 502 are in electrical communication. The size of the conductors 500 and 502 may vary depending upon the intended purpose of the conductors and requirements set forth in industry standards and/or regulations. The two or more conductors 500 and 502 may be the same size or the conductors may be different in size. To illustrate, in one embodiment, the conductors 500 and 502 may be the same size, such as a #6 AWG conductor, or in another embodiment where the conductors 500 and 502 may be the different size conductors, such as a #6 AWG conductor 500 and a #2 AWG conductor 502.

Continuing to refer to FIGS. 15-18, the connector body 120 may be a substantially rectangular member such that an exterior wall of the connector body is substantially square in shape, although other shaped members may be used to electrically connect two or more electrical conductors 500 and 502 together. Non-limiting examples of other shapes of the connector body 120 include cylindrical, conical and frustoconical shapes where the exterior wall of the connector body is substantially circular. The connector body 120 is preferably made of an electrically conductive material, such as an electrically conductive metal. Non-limiting examples of electrically conductive metals include copper, aluminum, aluminum alloys, stainless steel and brass. However, the present disclosure contemplates that other electrically conductive materials may be used to fabricate the connector body 120. Non-limiting examples of other electrically conductive materials include graphite and conductive polymers.

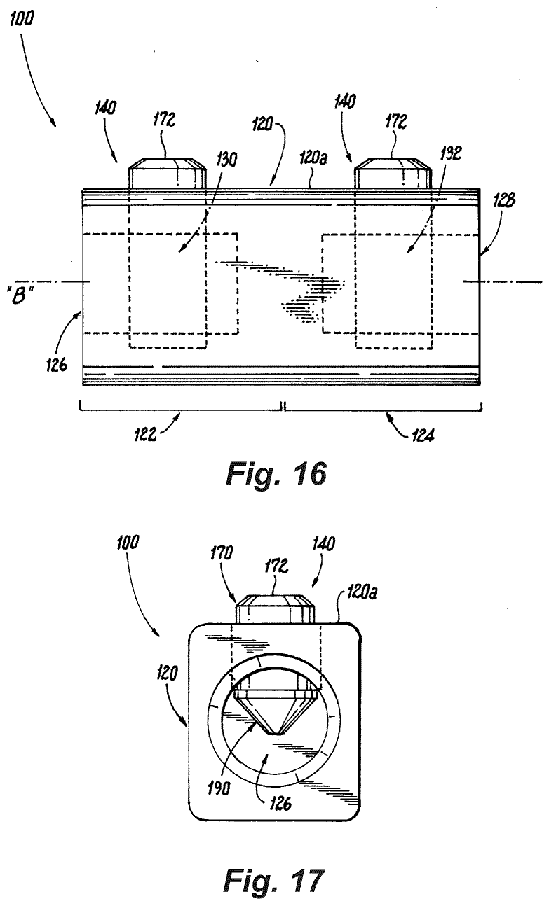

In the exemplary embodiment shown, the connector body 120 is an elongated body having a first end portion 122 and a second end portion 124, as shown in FIG. 16. The first end portion 122 of the connector body 120 includes an opening, bore or aperture 126 extending into the connector body 120 that is configured and dimensioned to receive a conductor 500, as shown in FIG. 24. The second end portion 124 of the connector body 120 includes an opening, bore or aperture 128 extending into the connector body 120 that is configured and dimensioned to receive a conductor 502, as shown in FIG. 24. The apertures 126 and 128 are preferably substantially cylindrical openings extending into the connector body 120 substantially parallel to the longitudinal axis “B” of the connector body 120. In the embodiment shown in FIG. 16, the apertures 126 and 128 are substantially in-line relative to each other. However, the present disclosure contemplates embodiments where the first aperture 126 is at an angle, e.g., a 90-degree angle, relative to the second aperture 128. The diameter of the apertures 126 and 128 are configured to receive the conductor 500 or 502 the aperture is designed to receive. To illustrate, in one embodiment where the conductors 500 and 502 are the same size, such as a #6 AWG conductor, the diameters of the apertures 126 and 128 would be sized to receive the #6 AWG conductor. In another embodiment, where the conductors 500 and 502 may be different size conductors, such as a #6 AWG conductor 500 and a #2 AWG conductor 502, the diameter of aperture 126 may be sized to receive the #6 AWG conductor 500 and the diameter of aperture 128 may be sized to receive the #2 AWG conductor 502.

Continuing to refer to FIGS. 15-18, the connector body 120 also includes a first fastener opening, aperture or bore 130 extending from a surface 120a of the connector body 120 into the connector body 120 a depth at least as far as to intersect with the first aperture 126, as shown in FIG. 16. The first fastener bore 130 is configured and dimensioned to receive one of the fasteners 140 so that the fastener 140 can secure the conductor 500 within aperture 126 with a friction fit or press fit connection. The connector body 120 also includes a second fastener opening, aperture or bore 132 extending from the surface 120a of the connector body 120 into the connector body 120 a depth at least as far as to intersect with the second aperture 128, as shown in FIG. 16. The second fastener bore 132 is also configured and dimensioned to receive one of the fasteners 140 so that the fastener 140 can secure the conductor 502 within the aperture 128 with a friction fit or press fit connection. The first fastener bore 130 may have a first diameter at the beginning of the first fastener bore 130, which is at the exterior of the connector body 120, and a second diameter at the end of the first fastener bore 130, which is at a point within the connector body 120 beyond a point where the first fastener bore 130 intersects with the conductor aperture 126. In some exemplary embodiments, the first and second diameters of the first fastener bore 130 may be the same, such that the diameter of first fastener bore 130 is constant. In other embodiments, the first and second diameters of the first fastener bore 130 may be different. For example, the first diameter may be the widest at the beginning of the first fastener bore 130 and the second diameter may be the narrowest at the end of the first fastener bore 130, and the first diameter may gradually decrease from the beginning to the second diameter at the end of the first fastener bore 130. Similarly, the second fastener bore 132 may have a first diameter at the beginning of the second fastener bore 132, which is at the exterior of the connector body 120, and a second diameter at the end of the second fastener bore 132, which is at a point within the connector body 120 beyond a point where the second fastener bore 132 intersects with the conductor aperture 128. In some exemplary embodiments, the first and second diameters of the second fastener bore 132 may be the same, such that the diameter of the second fastener bore 132 is constant. In other embodiments, the first and second diameters of the second fastener bore 132 may be different. For example, the first diameter may be the widest at the beginning of the second fastener bore 132 and the second diameter may be the narrowest at the end of the second fastener bore 132, and the first diameter may gradually decrease from the beginning to the second diameter at the end of the second fastener bore 132.

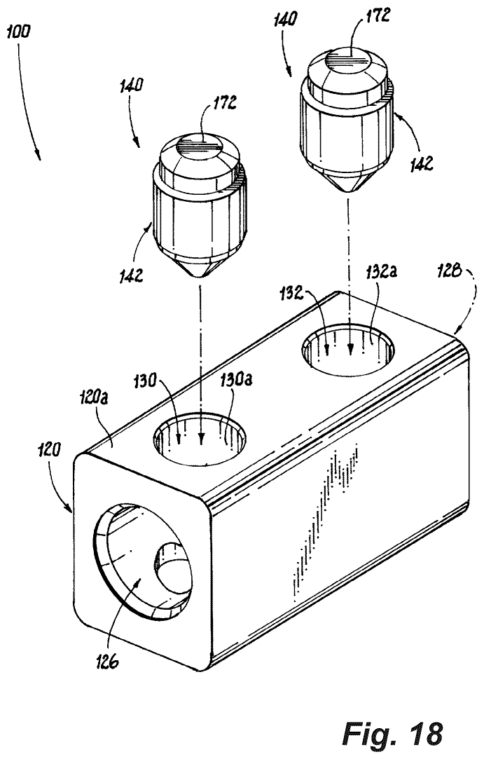

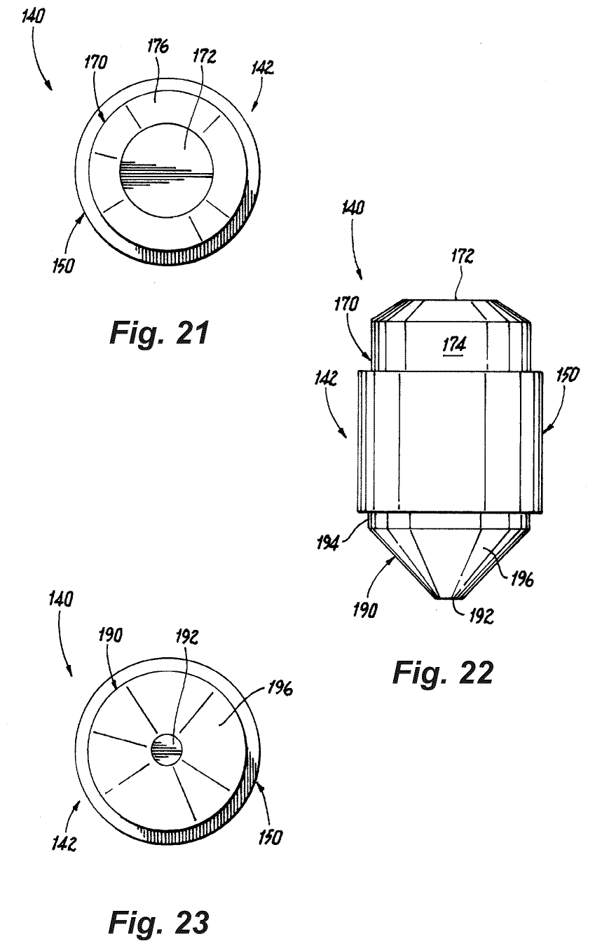

Referring to FIGS. 18-23, in the exemplary embodiment shown, the one or more fasteners 140 are pins configured to fit snuggly within the first fastener bore 130 and/or the second fastener bore 132 so that there is little to no gap between the fastener 140 and a wall 130a of the first fastener bore 130 and/or a wall 132a of the second fastener bore 130, seen in FIG. 18. The purpose of the snug fit is so that fastener 140 can, preferably, secure a conductor 500 or 502 within the first aperture 126 or the second aperture 128 with a friction fit or a press fit connection. For ease of description, the one or more fasteners 140 may also be referred to herein as the “pins” in the plural and the “pin” in the singular.

In some embodiments, the fastener 140 includes a fastener body 142 having a central portion 150, a first end portion 170 at the first end of the central portion 150 and a second end portion 190 at a second end of the central portion 150. In the exemplary embodiment shown, the fastener 140 may have an at least a partially cylindrical shape so that the shape of the fastener 140 corresponds to the shape of the first fastener bore 130 and/or the second fastener bore 132. However, the fastener body 142 may have any shape capable of being received in the first fastener bore 130 or the second fastener bore 132 so that a conductor 500 or 502 can be secured within the first and second apertures 126 and 128 of the connector body 120.

The central portion 150 of the fastener body 142 is disposed between the first end portion 170 and the second end portion 190. The central portion 150 may be substantially cylindrical shaped member that may be a solid member or partially hollow member. Preferably, the central portion 150 has an exterior wall 152 with a predefined diameter configured to fit snuggly within the first fastener bore 130 and/or the second fastener bore 132 so that so that the fastener body 142 can secure a conductor 500 within the first aperture 126 or a conductor 502 within the second aperture 128 with a friction fit or a press fit connection.

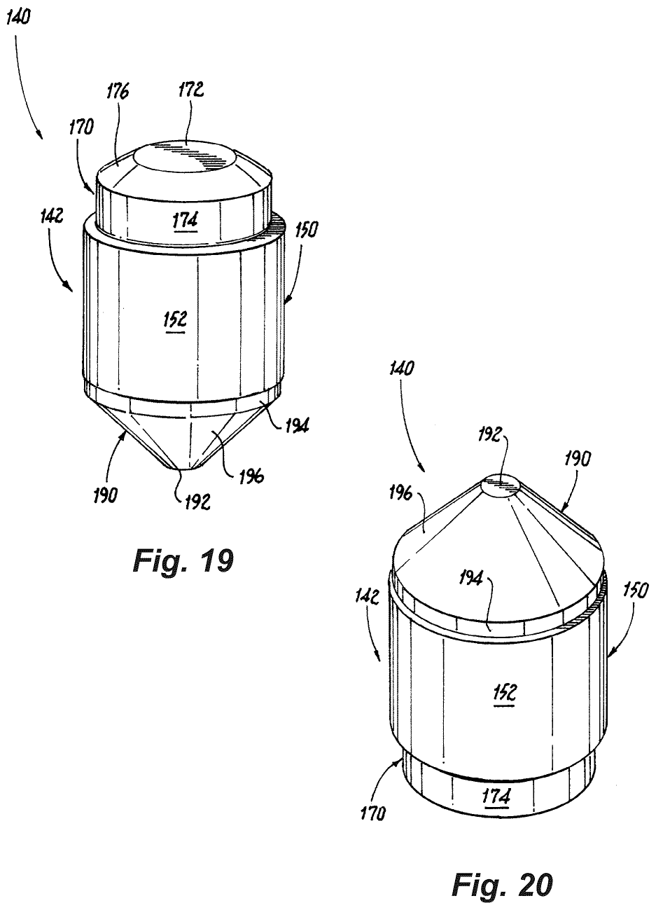

Continuing to refer to FIGS. 18-23, the first end portion 170 of fastener body 142 includes an impact surface 172, which may be a substantially flat surface, seen in FIGS. 18 and 19, that forms at least partially an impact surface used when hammering the fastener 140 into engagement with the conductor 500 or 502 to secure the conductor to the connector body 120. The impact surface 172 is a circular shaped surface, although other shapes, e.g., elliptical, triangular, rectangular, etc., for the impact surface 172 may also be used. In some embodiments, a diameter of the circular impact surface 172 may be smaller than a diameter of the exterior wall 174 of the first end portion 170 of the fastener body 142 so that the impact surface 172 is a raised surface. The impact surface 172 is raised by, for example, a stepped wall, a curved wall, an inclined wall or another shaped wall 176. In the embodiment shown, wall 176 is an inclined wall. The outer diameter of the exterior wall 174 of the first end portion 170 may be smaller than the outer diameter of the exterior wall 152 of the central portion 150. The transition between the exterior wall 152 of the central portion 150 and the exterior wall 174 of the first end portion 170 may be, for example, stepped, curved, inclined or another shaped. In the exemplary embodiment shown, the transition between the exterior wall 152 of the central portion 150 and the exterior wall 174 of the first end portion 170 is stepped.

Continuing to refer to FIGS. 18-23, the second end 190 of the fastener body 142 includes a contact surface 192, which may be a substantially flat surface, seen in FIG. 20, that forms at least partially a contact surface used to compress the conductor 500 or 502 against the fastener body 142 when the impact surface 172 of the fastener 140 is hammered into engagement with the connector body 120 to secure the conductor 500 or 502 to the connector body 120. The contact surface 192 may be a circular shaped surface, although other shapes, e.g., elliptical, triangular, rectangular, etc., for the contact surface 192 may also be used. In some embodiments, a diameter of the circular contact surface 192 may be smaller than a diameter of the exterior wall 194 of the second end 190 of the fastener body 142 so that the contact surface 192 is a raised surface. The contact surface 192 is raised by, for example, a stepped wall, a curved wall, an inclined wall or another shaped wall 196. In the embodiment shown, wall 196 is an inclined wall. It is noted that in instances where the contact surface 192 is substantially smaller than the diameter of the exterior wall 194 of the second end 190, as shown in FIG. 20, at least a portion of wall 196 may also form a portion of the contact surface 192. All or a portion of the contact surface 192 may be textured (not shown) with, for example, ridges, knurling or other rough surface textures. The texture would be provided to enhance the electrical contact between the contact surface 192 and the conductor 500 or 502. In some embodiments, the surface area of contact surface 192 may be at least about 10% of the surface area of the impact surface 172. In other embodiments, the surface area of contact surface 192 may be at least about 25% of the surface area of the impact surface 172. In other embodiments, the surface area of the contact surface 192 may be at least about 50% of the surface area of the impact surface 172. In still other embodiments, the surface area of the contact surface 192 may be at least about 60% of the surface area of the impact surface 172. In other embodiments, the surface area of contact surface 192 may be at least about 75% of the surface area of the impact surface 172. In still other embodiments, the surface area of the contact surface 192 may be at least about 100% of the surface area of the impact surface 172. It is noted that a larger surface area of the contact surface 192 may more evenly distribute forces across the electrical conductor 500 or 502 so that the force can be applied to, for example, multiple strands of electrical conductor that may be stranded wire.

In the exemplary embodiment shown, the outer diameter of the exterior wall 194 of the second end portion 190 of the fastener body 142 may be smaller than the outer diameter of the exterior wall 152 of the central portion 150 and larger than the diameter of the exterior wall 174 of the first end portion 170. In some embodiments, the transition between the exterior wall 152 of the central portion 150 and the exterior wall 194 of the second end portion 190 may be, for example, stepped, curved, inclined or another shaped. In the exemplary embodiment shown, the transition between the exterior wall 152 of the central portion 150 and the exterior wall 194 of the second end portion 190 is stepped. In this configuration, the step between the central portion 150 and the second end portion 190 may be smaller than the step between the central portion 150 and the first end portion 170. However, in other embodiments, the outer diameter of the exterior wall 194 of the second end portion 190 of the fastener body 142 may be substantially the same size as the outer diameter of the exterior wall 152 of the central portion 150 so that there is substantially no transition between the exterior wall 152 of the central portion 150 and the exterior wall 194 of the second end portion 190.

The fasteners 140 are configured to withstand an impact from a hammer or other suitable tool used drive or otherwise cause the fastener 140 to move within the fastener bore 130 or 132 until the contact surface 192 of the second end 190 of the fastener body 142 applies sufficient force on the conductor 500 or 502 to indent the conductor to secure the conductor 500 or 502 to the connector body 120. The fasteners 140 may be solid members, hollow members or partially hollow members. The fasteners 140 are preferably made of an electrically conductive material, such as an electrically conductive metal. Non-limiting examples of electrically conductive metals include copper, aluminum, aluminum alloys, stainless steel and brass. However, the present disclosure contemplates that other electrically conductive materials may be used to fabricate the fasteners 140. Non-limiting examples of other electrically conductive materials include graphite and conductive polymers.

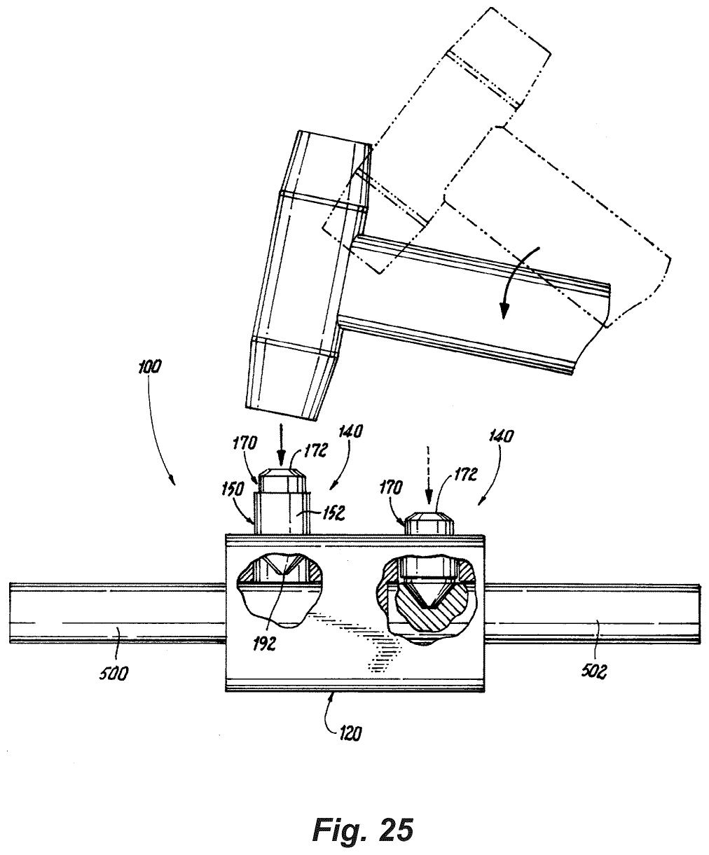

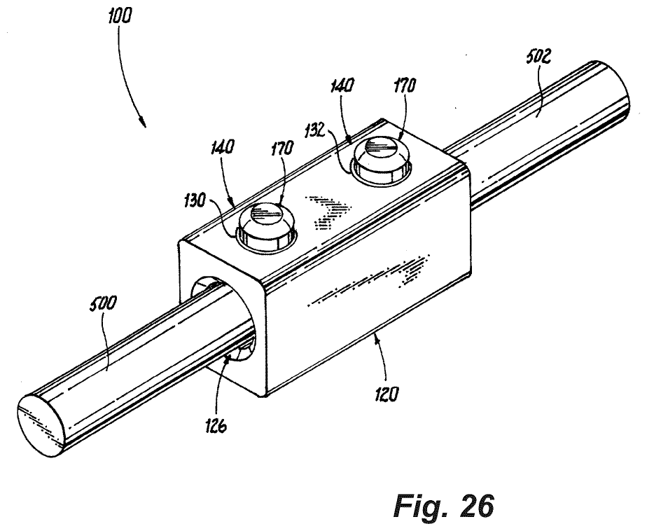

Referring now to FIGS. 24-26, an exemplary description for securing the conductors 500 and 502 to the connector assembly 100 is provided. In this exemplary embodiment, the two fasteners 140 are in an open position where conductors 500 can be inserted into the conductor apertures 126 in the connector body 120, and where conductor 502 can be inserted into the conductor apertures 128 in the connector body 120. A technician then impacts the impacting surface 172 of the first end portion 170 of fastener body 142 with a hammer or other suitable tool causing the fastener 140 to move within the fastener bore 130 or 132 until the contact surface 192 of the second end 190 of the fastener body 142 applies sufficient force on the conductor 500 or 502 to indent the conductor to secure the conductor 500 or 502 to the connector body 120. As the fastener 140 moves within the fastener bore 130 or 132, friction between one or all of the pin walls and the wall of the fastener bores 130 or 132 increases sufficiently to form friction fit or press fit connection between the connector body 120 and the fastener 140 to irreversibly or permanently connect or join the electrical conductors 500 and 502 together as shown in FIGS. 25 and 26.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What is claimed is:

1. A connector assembly comprising:
a connector body having a plurality of conductor apertures and a plurality of fastener bores, each of the plurality of conductor apertures extend through the connector body from one side of the connector body to an opposite side of the connector body, and each of the plurality of fastener bores extend from an end of the connector body into the connector body a predefined depth so that one fastener bore intersects one conductor aperture; and
a plurality of fasteners, wherein one of the plurality of fasteners is positioned in one of the plurality of fastener bores, each of the plurality of fasteners having an impacting surface at a first end portion of the fastener and a wire contact surface at a second end portion of the fastener, wherein the impacting surface extends outside the one fastener bore and the contact surface is within the intersection between the one fastener bore and the one conductor aperture.

2. The connector assembly according to claim 1, wherein an exterior wall of the connector body is shaped as a circular wall or as a square wall.

3. The connector assembly according to claim 1, wherein the plurality of conductor apertures are substantially parallel.

4. The connector assembly according to claim 1, wherein each of the plurality of fasteners includes a body having a central portion disposed between the first end portion and the second end portion, wherein at least the central portion includes an exterior wall that is configured to fit snuggly within the one fastener bore such that there is little to no gap between the exterior wall of the central portion and an interior wall of the one fastener bore.

5. The connector assembly according to claim 1, wherein the wire contact surface is configured such that when in use, the wire contact surface can indent a conductor positioned within the one conductor aperture.

6. The connector assembly according to claim 1, wherein an exterior wall of the second end portion of the fastener is tapered such that a smaller end of the taper forms the wire contact surface.

7. The connector assembly according to claim 1, wherein each of the plurality of fasteners includes a body having a central portion disposed between a first end portion and a second end portion, wherein a shape of an exterior wall of the central portion is substantially the same as a shape of the one fastener bore.

8. The connector assembly according to claim 7, wherein the shape of the one fastener bore is substantially circular and the shape of the exterior wall of the central portion is substantially circular.

9. A connector assembly comprising:
a connector body having a plurality of conductor apertures and a plurality of fastener bores, each of the plurality of conductor apertures extend from one end of the connector body into the connector body a predetermined depth, and each of the plurality of fastener bores extend from a side of the connector body into the connector body a predefined depth such that one fastener bore intersects one conductor aperture; and
a plurality of fasteners, wherein one of the plurality of fasteners is positioned in one of the plurality of fastener bores, each of the plurality of fasteners having an impacting surface at a first end portion of the fastener and a wire contact surface at a second end portion of the fastener, wherein the impacting surface extends outside the respective fastener bore and the contact surface is within the intersection between the one fastener bore and the one conductor aperture.

10. The connector assembly according to claim 9, wherein an exterior wall of the connector body is shaped as a circular wall or as a square wall.

12. The connector assembly according to claim 9, wherein the plurality of fastener bores are substantially parallel.

13. The connector assembly according to claim 9, wherein each of the plurality of fasteners includes a body having a central portion disposed between the first end portion and the second end portion, wherein at least the central portion includes an exterior wall that is configured to fit snuggly within the one fastener bore such that there is little to no gap between the exterior wall of the central portion and an interior wall of the one fastener bore.

14. The connector assembly according to claim 9, wherein the wire contact surface is configured such that when in use, the wire contact surface can indent a conductor positioned within the one conductor aperture.

15. The connector assembly according to claim 9, wherein an exterior wall of the second end portion of the fastener is tapered such that a smaller end of the taper forms the wire contact surface.

16. The connector assembly according to claim 9, wherein each of the plurality of fasteners includes a body having a central portion disposed between the first end portion and the second end portion, wherein a shape of an exterior wall of the central portion is substantially the same as a shape of the one fastener bore.

17. The connector assembly according to claim 16, wherein the shape of the one fastener bore is substantially circular and the shape of the exterior wall of the central portion is substantially circular.

18. A connector assembly comprising:
a connector body that includes:
first and second conductor apertures, the first aperture extends through the connector body from one side of the connector body to an opposite side of the connector body, and the second aperture extends through the connector body from one side of the connector body to an opposite side of the connector body;
first and second fastener bores, the first fastener bore extends from a first end of the connector body into the connector body a predefined depth so that the first fastener bore intersects the first conductor aperture, and the second fastener bore extends from a second end of the connector body into the connector body a predefined depth so that the second fastener bore intersects the second conductor aperture; and
a first fastener positioned in the first fastener bore, the first fastener includes an impacting surface at a first end portion of the first fastener and a wire contact surface at a second end portion of the first fastener, wherein the impacting surface extends outside the first fastener bore and the contact surface is within the intersection between the first fastener bore and the first conductor aperture; and
a second fastener positioned in the second fastener bore, the second fastener includes an impacting surface at a first end portion of the second fastener and a wire contact surface at a second end portion of the second fastener, wherein the impacting surface extends outside the second fastener bore and the contact surface is within the intersection between the second fastener bore and the second conductor aperture.

19. The connector assembly according to claim 18, wherein each of the first and second fasteners includes a body having a central portion disposed between the first end portion and the second end portion, wherein at least the central portion includes an exterior wall that is configured to fit snuggly within the first or second fastener bores such that there is little to no gap between the exterior wall of the central portion and an interior wall of the first or second fastener bores.

20. The connector assembly according to claim 18, wherein the wire contact surface of the first and second fasteners is configured such that when in use, the wire contact surface can indent a conductor positioned within the first or second conductor aperture.

21. The connector assembly according to claim 18, wherein an exterior wall of the second end portion of the first and second fasteners is tapered such that a smaller end of the taper forms the wire contact surface.
